(19) United States
(12) Patent Application Publication
(10) Pub. No.: US 2012/0131882 A1
(43) Pub. Date: May 31, 2012

(54) METHOD FOR PRODUCING A LAMINATED VACUUM-TIGHT CONNECTION BETWEEN A GLASS PANE AND A METAL FRAME, AND LAMINATED GLASS PANE CONNECTION

(76) Inventors: Dieter Sporn, Hameln (DE); Werner Hartman, Gerbrunn (DE); Rolf Ostertag, Rottenburg/Neckar (DE); Jürgen Meinhardt, Amsteln (DE); Manfred Krauss, Jena (DE)

(21) Appl. No.: 12/995,105

(22) PCT Filed: May 26, 2009
(86) PCT No.: PCT/EP2009/003741

§ 371 Date: Jun. 27, 2011

(30) Foreign Application Priority Data
May 30, 2008 (DE) 10 2008 025 945.4

(51) Int. Cl. E04C 2/34; C03C 27/04

(52) U.S. Cl. 52/788.1; 65/41

(57) ABSTRACT

The present invention relates to a method for producing a laminated vacuum-tight connection between the glass pane and the frame, wherein said connection is formed by a thermal soldering material and can be produced directly by a soldering process, during which soldering material inserted between the frame and the glass pane is melted. For this purpose, during the manufacturing process, the glass pane receives the properties of a tempered safety glass pane (TSG) pursuant to DIN 12150-1.

The present invention relates to a method for producing a laminated vacuum-tight connection between a glass pane and the frame, wherein said connection is formed by a thermal soldering material and can be produced directly by a soldering process, during which soldering material inserted between the frame and the glass pane is melted. Unless no other chemically or thermally prestressed glass is already used, the glass pane obtains the properties of tempered safety glass (TSG) in accordance with DIN 12150-1 during the production process.

For the production and the operation of transparent vacuum components in the energy and windowing technology it is necessary to design the edge seal between the TSG glass pane and the frame/support such that it is durable, i.e. able to maintain the ultimate pressure on the inside around 1 Pa over a period of 15 to 20 years. This seal, also referred to as edge seal, due to physical reasons can only consist of glass/glass or glass/metal laminations, since gas-tight connections are possible only with these combinations. A mandatory stipulation in the building industry is the use of TSG safety glass, for instance in vacuum flat-plate collectors. During the production, the fracturing properties are adjusted by means of a thermal induction hardening step such that the pane disintegrates into relatively small pieces without sharp edges and corners during destruction. But for the installation of TSG safety glass panes for covering evacuated-tube collectors it is necessary, however, that glass panes are thermally bonded or welded to the border. This energy input destroys the TSG characteristics. Following this treatment, the glass pane is stress-relieved (through loss of the compressive stresses on the surface), breaks apart into large, sharp-edged fragments, and is therefore no longer certified for use in the building industry. With the components for vacuum flat-plate collectors to be welded, this involves large-sized, flat components with joint lengths of several meters, which is different to the state-of-the-art.

Vacuum-tight glass/metal laminations have been known for many years inter alia from lamp technology, but these seals have small geometric dimensions, and lamp glass has no TSG characteristics. There is therefore no practical solution at present for the vacuum-tight joining of large-surface components, where at least one component represents a TSG glass pane. A number of printed patent specifications, such as DE 100 85 030 and DE 69 429 699 describe the connection of two glass panes in order to represent VIG (vacuum insulating glass), but as far as the inventors know, the possibilities for solving the problem do not present a technically feasible solution up to this point. Large-surface glass panes and the metal borders that can be welded or soldered together so that they are then permanently vacuum-tight and have TSG characteristics, are not known up to this point.

The object of the invention therefore is to find a process that permits vacuum-tight welding in the peripheral area of large-sized cover plates and at the same time makes it possible that this glass has TSG characteristics. At the same time, the number of the necessary process steps during the entire manufacturing sequence should be minimized.

This problem with respect to the method for producing the vacuum-tight connection between the glass pane and a frame with the features of Claim 1, as well as with respect to the tempered safety glass to be welded and/or soldered to the frame is solved with the features of Claim 13. In this context, the respective dependent Claims represent advantageous developments. Claim 17 indicates the intended uses of the tempered safety glass pane.

The invention therefore teaches that a method for producing a vacuum-tight edge seal between a glass pane and at least one first frame arranged in the peripheral area of the first side of the glass pane is provided, wherein the at least one first frame is sized such that it bears at least with a part of its surface peripherally on the peripheral area of the first side of the glass pane, in which
a) a thermally liquefiable solder material is applied on the contact surface of the first frame and/or at least partially on the contact surface of at least the first side of the glass pane,
b) the glass pane with the first side is placed on the first frame, so that a continuous contact surface between the first side of the glass pane and the first frame results peripherally,
c) heating the arrangement of the glass pane and the at least one first frame to a temperature at which the liquefaction of the solder material is ensured, so that the liquefied solder material forms a peripheral film between the first frame and the glass pane, as well as
d) sufficiently rapid cooling of the obtained connection so that after the cooling, the pane comprises the material characteristics of tempered safety glass (TSG) pursuant to DIN 12150-1.

It is therefore essential for the invention that a durable, vacuum-tight connection between a glass pane and a frame for mounting the glass pane can be made in one single step process, and in which the glass pane receives or maintains specific thermal prestressing and therefore receives the material characteristics of a tempered safety glass or for the case that glass is used that has a already been prestressed, these are retained after the process. During the use of non-prestressed glass, the cooling step d) is therefore especially important in order to prestress the glass material used. This is applicable equally, if a previously prestressed glass pane is used as the glass pane of which the TSG characteristics can be lost during the tempering step c). In case that chemically prestressed glass materials are used, the tempering step c) is especially important, however. This follows from the structure of chemically prestressed glass. With chemically prestressed glass, part of the Na⁺ ions is replaced by Ca²⁺ ions in the final coat of the glass material, for example, which is the reason for the prestressing. The temperature range as well as the time of the tempering step c) must therefore be selected during the soldering of prestressed glass such that a complete diffusion and homogenization of the Ca²⁺ ions within the glass material and therefore a loss of the Ca²⁺ ion gradients within the glass material does not occur and that the prestressing is consequently retained. In addition, such materials can however possibly also acquire a certain thermal stress during the cooling step d). The respective conditions concerning the aforementioned glass materials that can be used are at the disposal of a skilled person by means of some simple experiments. For the glass panes that can be used, all sorts of materials can be considered here, although soda lime silicate flat glass and/or borosilicate flat glass is preferred.

The most important advantage of the invention consists in that the vacuum-tight edge seal lamination (metal frame/glass solder/TSG lamination or metal frame/metal solder/TSG lamination) and the adjustment of the TSG characteristics can be accomplished by quenching of the frame/glass pane construction by means of cold air.

As an alternative, a glass/metal composite or a metal solder can be used between the glass pane and the steel frame.

In a preferred embodiment, the glass pane is embedded between two frames. The process of manufacture of the aforementioned connection is defined in the preferred embodiment pursuant to claim 2, in which
a) a liquefiable solder material is applied at least partially on the contact surface of the first frame and/or at least partially on the contact surface of the first and/or the second side of the glass pane,
b) the glass pane with the first side is placed on the first frame, so that a continuous contact surface between the first side of the glass pane and the first frame results peripherally,
c) the second frame is placed on the second side of the glass pane, so that a continuous contact surface between the second side of the glass pane and the second frame results peripherally,
d) heating the arrangement of the first frame, glass pane and the second frame to a temperature at which the liquefaction of the solder material is ensured, so that the liquefied solder material forms a peripheral film between the first frame of the glass pane and the second frame, as well as
e) sufficiently rapid cooling of the obtained connection so that after the cooling the pane comprises the material characteristics of tempered safety glass (TSG) pursuant to DIN 12150-1.

In this process it is advantageous that a more stable connection between the glass pane is provided, and the vacuum-tight characteristics are also increased between the pane and the frame because of the greater laminated surface.

In this context, the application of the thermally liquefiable soldering material can be in solid form, as a dispersion of a powder in a carrier liquid, as a paste or as a cord.

Especially preferred here is the application within the scope of the silk-screen process.

In a preferred embodiment, the solder material has a transition temperature T_{g} between 250 and 700° C., preferably between 300 and 550° C.

The preferred soldering materials used are materials from the group consisting of glass solders, metal solders and/or combinations or mixtures thereof. Particularly suited for this purpose are lead-free, stable glass solders that do not crystallize during melting, such as alkaline earth borosilicate glass, alkali/alkaline earth silicate glass and FeO-doped silicate glass.

In this context it is further advantageous, if the solder material has a thermal coefficient of expansion α between 1 and 30 within a temperature range of 20° C. to 300° C., preferably between 8 and 11 (in 10⁻⁶/K).

In order to facilitate a connection between the solder material and the frame that is as stable as possible and to prevent crack formation during heating and cooling, particularly frame material substances are considered in which the thermal coefficient of expansion deviates by 10% maximum, preferably 8% maximum, further preferred 7% maximum, particularly preferred 6% maximum of the thermal coefficient of expansion of the solder material.

Particularly preferred frame materials here are metals or metal alloys, in particular steel, but especially ferritic chromium steel.

In order to ensure a connection between the solder material and the frame that is as effective as possible, it is further preferred if the first and/or the second frame prior to step a) is subjected to heat treatment at standard atmosphere, i.e. air, preferably at temperatures between 500 and 800° C. and/or an adhesion promoter layer is applied at least in the area of the contact surface of the first and/or second frame, in particular selected from the group consisting of organosilicon compounds, silanes, SiO₂, silicates, metal oxides such as TiO₂ and/or ZrO₂, spinels, perovskite, and/or Al₂O₃.

Is further advantageous, if a compressive stress is applied on the arrangement of frame, solder material and glass pane prior to heating, in order to fix the arrangement from the loose individual components not yet connected, but it is also advantageous, if a compressive stress is applied on the aforementioned arrangement after cooling.

During the thermal heating step, temperatures of 500 to 800° C. are preferred, preferably 550 to 650° C.

In this instance, the thermal treatment step should be between 0.1 to 120 min., preferably 1 to 10 minutes.

In another further advantageous embodiment, the coating step is done by means of applying cold air (blower) to the arrangement until reaching temperatures below 500° C., preferably below 350° C. within a time of 0.5 to 5 minutes, preferably from 0.5 to 1 min. In this respect it is advantageous here, if the cooling process is done as quickly as possible, i.e. that it resembles quenching. For this purpose, cold air can be used, the temperature of which is preferably in the temperature range of −100° C. to +50° C., preferably 10 to 30° C.

The invention teaches that likewise a tempered safety glass pane pursuant to DIN 12150-1 is provided that is hermetically connected peripherally with at least one peripheral area on at least one first side of the pane, where the at least one first frame is sized such that it bears upon at least with a part of its surface peripherally on the peripheral area of the first side of the glass pane, characterized in that the connection is accomplished by a solder material. The advantage of the previously described connection should be seen in that because of the direct connection of the glass pane with a frame a highly efficient and extended durable vacuum-tight connection of the glass pane with the frame is provided. The glass pane additionally comprises the material characteristics pursuant to DIN 12150-1, so that a broad application spectrum results for the laminated glass pane connection.

The features of the pane essential for the invention are therefore: the frame (in its feasible geometric configuration and its material selection, preferably ferritic chromium steel) secondly the matched glass or metal solder between frame and glass, and the TSG characteristics of the pane.

In a preferred embodiment, here the glass pane is enclosed sandwiched between two frames, where it is connected with each frame. This special embodiment is defined in claim 14.

The thickness of the solder material layer connecting the frame and the glass pane is preferably between 2 μm and 5 mm, preferably between 2 and 200 μm, particularly preferred between 4 and 100 μm, where the layer thickness is dependent upon the application method of the solder material in the method as taught by the invention. In this connection, the silk-screen process is particularly preferred, as already previously mentioned.

Potential uses of the tempered safety glass pane pursuant to the present invention are in the form of vacuum insulating glass, industrial glass, flat plate collector glass, safety glass and/or evacuated-tube collectors. The TSG tempered safety glass pane is especially suited as vacuum insulating glass (VIG) and/or for vacuum flat-plate collectors for collection of thermal energy (e.g. solar thermal collectors).

The subject matter of the present invention is explained in detail using the enclosed Figures and the following embodiments, without limiting the invention to the parameters specified there,

as follows:

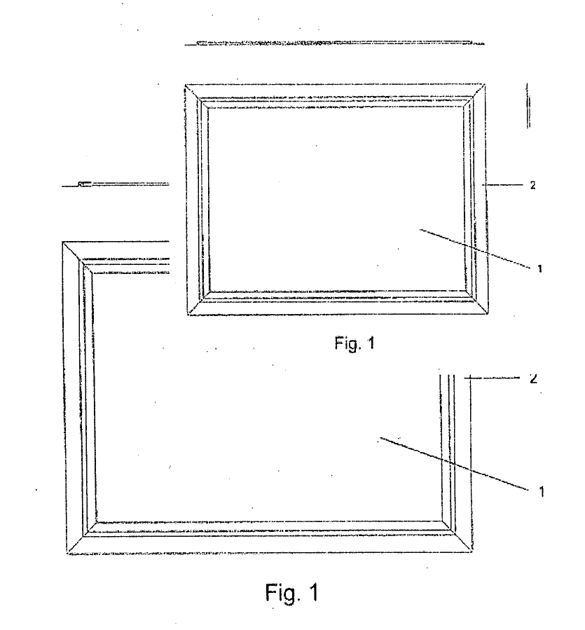

FIG. 1: is a tempered safety glass pane as taught by the invention with a vacuum-tight edge seal based upon the double-frame principle in a horizontal projection, as well as

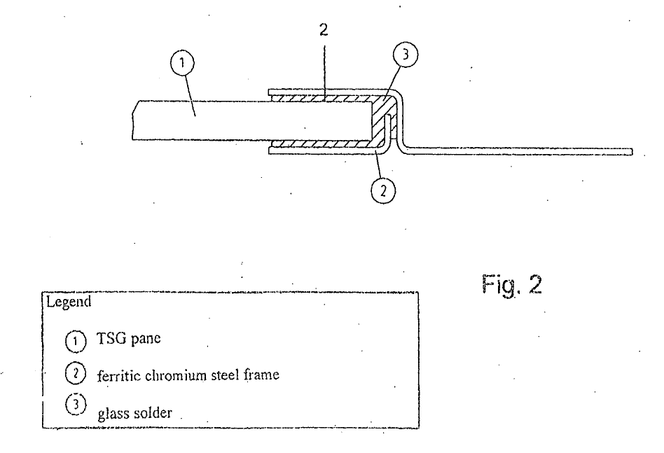

FIG. 2: is a tempered safety glass pane as taught by the invention with a vacuum-tight edge seal based upon the double-frame principle as a cross section.

In this connection, FIG. 1 represents an embodiment of a TSG glass pane 1 as taught by the invention, which is welded together with a frame 2 using a solder connection. The frame 2 in this context is proportionately larger than the TGS glass pane 1, so that merely a part of the surface of the frame 2 is connected with the pane 1.

FIG. 2 represents a special embodiment, according to which the pane 1 is enclosed between two frames like a sandwich, where the flat spacing between the TSG pane 1 and the two frames 2 are filled with a glass solder 3 in this case. The spacing is therefore completely filled by the glass solder 3, so that excellent hermetic characteristics result.

1. A method for producing a vacuum-tight edge seal between a glass pane and a first frame arranged in a peripheral area on a first side of the glass pane, comprising:
applying a thermally liquefiable solder material on at least one of a contact surface of the first frame and at least partially on a contact surface of at least the first side of the glass pane;
placing the glass pane with the first side on the first frame, so that a continuous contact surface between the first side of the glass pane and the first frame results peripherally;
heating the glass pane and the first frame to a temperature at which the liquefaction of the thermally liquefiable solder material is ensured, so that the thermally liquefiable solder material forms a peripheral film between the first frame and the glass pane; and
cooling the thermally liquefiable solder material so that after the cooling, the pane comprises the material characteristics of tempered safety glass (TSG) pursuant to DIN 12150-1.

2. The method according to claim 1, including
applying the thermally liquefiable solder material at least partially on the contact surface of the first frame and at least partially on a contact surface of the second side of the glass pane;
placing the second frame on the second side of the glass pane so that a continuous contact surface between the second side of the glass pane and the second frame results peripherally;
heating of the first frame, glass pane and the second frame to a temperature at which the liquefaction of the thermally liquefiable solder material is ensured, such that the thermally liquefied solder material forms a peripheral film between the first frame of the glass pane and the second frame; and
cooling the thermally liquefiable solder material so that after the cooling the glass pane comprises the material characteristics of a tempered safety glass pane pursuant to DIN 12150-1.

3. (canceled)

4. The method according to claim 1, where the thermally liquefiable solder material is selected from the group consisting of glass solders, metal solders and combinations or mixtures thereof.

5. The method according to claim 1, where the thermally liquefiable solder material has a thermal coefficient of expansion α of 1 to 30 at 20° C. to 300° C.

6. (canceled)

7. The method according to claim 2, where the at least one of the first frame and the second frame consists of metal or metal alloys.

8. The method according to claim 2, where at least one of the first and the second frame prior to applying the thermally liquefiable solder material is subjected to a heat treatment at standard atmosphere and a temperature in a range of 500 and 800° C.

9. The method according to claim 1, further including applying a compressive stress to the thermally liquefiable solder material after cooling.

10. The method according to claim 1, where heating is up to temperatures of 500 to 800° C.

11. The method according to claim 1, where the heating is performed over 0.1 to 120 minutes.

12. The method according to claim 1, where cooling includes applying cold air to the glass pane and the first frame until the thermally liquefiable solder material reaches a temperature below 500° C. within a time of 0.5 to 5 minutes.

13.-17. (canceled)

18. The method according to claim 2, where at least one of the first frame and the second frame consists of a material of which the thermal coefficient of expansion deviates by 10% maximum of the thermal coefficient of expansion of the thermally liquefiable solder material.

19. The method according to claim 2, including applying an adhesion promoter layer to at least one of the first frame and the second frame prior to applying the thermally liquefiable solder material, where the adhesion promoter layer is applied at least in the area of the contact surface of the first frame and the second frame, the adhesion promoter layer being selected from the group consisting of organosilicon compounds, silanes, SiO₂, silicates, metal oxides, spinels, perovskite, Al₂O₃ and combinations thereof.

20. The method according to claim 1, where the thermally liquefiable solder material has a transition temperature T_{g} between 250 and 700° C.

21. A structure, comprising: a glass pane of tempered safety glass pursuant to DIN 12150-1 hermetically connected along a peripheral area on at least one first side of the glass pane to a first frame with a thermally liquefiable solder material.

22. The structure according to claim 21, where a second side of the glass pane is hermetically connected along a peripheral area to a second frame with the thermally liquefiable solder material.

23. The structure according to claim 21, where the thickness of the thermally liquefiable solder material is between 2 μm and 5 mm.

24. The structure according to claim 21, where the thermally liquefiable solder material has a transition temperature T_{g} between 250 and 700° C.

25. The structure according to claim 21, where the thermally liquefiable solder material has a thermal coefficient of expansion α of 1 to 30 at 20° C. to 300° C. (10⁻⁶/K).

26. A structure, comprising: a glass pane of tempered safety glass pursuant to DIN 12150-1 hermetically connected along a peripheral area on at least one first side of the glass pane to a first frame with a thermally liquefiable solder material produced according to the method of claim 1.

27. The structure according to claim 26, where the glass pane is one of a vacuum insulating glass, an industrial glass, a flat plate collector glass, a safety glass or for an evacuated-tube collector.
